(19) United States
(12) Patent Application Publication
(10) Pub. No.: US 2004/0027820 A1
(43) Pub. Date: Feb. 12, 2004

(54) Device for illumination of photographic camera controls and displays

(76) Inventor: Thomas Hilmersen, Boulder, CO (US)

Correspondence Address: Thomas Hilmersen, 555 South 44th Street, Boulder, CO, 80305, US

(21) Appl. No.: 10/213,495

(22) Filed: Aug. 8, 2002

(51) Int. Cl. G03B 15/02; F21V 33/00

(52) U.S. Cl. 362/8; 362/9; 362/253; 362/16

(57) ABSTRACT

This patent application is for a camera-mounted device designed to illuminate the displays and controls of a photographic camera under low light conditions. The invention consists of a light emitting unit attached to a DC power source housing unit via a flexible arm. The illumination device enables the operator of a photographic camera to easily read the displays and adjust the controls of said camera under low light conditions.

This patent application is for an illumination device which can be mounted onto a photographic camera via such camera's hot shoe bracket. The illumination device enables the camera operator to view the controls and displays of the camera under low light condition. The application is filed by Thomas Hilmersen, 555 South 44^{th} Street, Boulder, Colo. 80305. (303) 494 0824.

### CROSS-REFERENCE TO RELATED APPLICATIONS

U.S. Patent Documents

| D238959 | February 1976 | Kurokawa | D26/107 |
|---|---|---|---|
| D251687 | April 1979 | Kurokawa | D26/107 |
| D377840 | February 1997 | Chang | D26/62 |
| D418240 | December 1999 | Sherman | D26/63 |
| 1,651,307 | November 1927 | Wilkinson | 362/195 |
| 3,065,339 | November 1962 | Fahey, Jr. | 362/308 |
| 5,122,937 | June 1992 | Stoudemire | 362/109 |
| 5,122,941 | June 1992 | Gross, et al | 362/276 |
| 5,136,477 | August 1992 | Lemmey | 362/198 |
| 5,183,325 | February 1993 | Hurdle | 362/109 |
| 5,379,201 | January 1995 | Friedman | 362/191 |
| 5,615,945 | Apilr 1997 | Tseng | 362/226 |
| 6,318,873 | November 2001 | Naghi, et al | 362/85 |

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISC APPENDIX

Not applicable.

### BACKGROUND OF THE INVENTION

The present invention is in the field of lighting devices for photographic cameras, specifically a device designed to illuminate the camera body itself rather than the subject of photography.

Although the majority of photographs are taken in conditions when the existing light is adequate to enable efficient operation of a photographic camera, the photography enthusiast frequently encounters situations when this is not the case. When photographing in low-light conditions, the photographer may only have access to the information shown via LEDs or a backlit LCD inside his camera finder. He may be unable to accurately read the controls and displays located externally on the camera body, unless said controls and displays are backlit or otherwise illuminated. Although there exist several photographic cameras that have backlit displays and controls, most cameras in use today do not have such conveniences.

Accordingly, there is a long felt need for a simple, economical and light-weight device that can illuminate photographic camera displays and controls.

### BRIEF SUMMARY OF THE INVENTION

The present invention is generally directed to an apparatus for illuminating a photographic camera's controls and displays. It is mounted onto the camera via the camera's hot shoe bracket and is powered by a small battery, independent of the photographic camera's power source. In a first, separate aspect of the present invention, the illumination device is a light emitting diode. A white light diode is especially preferred. In another, separate aspect of the present invention, the illumination apparatus includes a flexible arm. This flexible arm can be adjusted as to adjust the height or angle of the illumination device relative to the photographic camera's displays and controls. In addition, other devices, such as a diffuser, a magnifier, or a regulator for varying the intensity of light, can be added to the illumination apparatus.

The invention is a potentially simple, economical and light-weight means of illuminating photographic camera displays and controls.

The ability to mount the illumination device directly onto the camera body, via the camera's hot shoe, means that the invention will work with most photographic cameras currently in production—as most such cameras are equipped with a hot shoe bracket.

### BRIEF DESCRIPTION OF THE SEVERAL VIEWS OF THE DRAWING

FIG. 1 is a schematic representation of a preferred embodiment of the present invention. It shows the illumination device attached to a typical 35 mm single lens reflex photographic camera, as seen by an observer facing the front of said camera. The present invention does not relate to the camera shown in the drawing.

FIG. 2 shows a detail of the invention, as seen by an observer facing the rear of said camera. Specifically, FIG. 2 shows the DC power source housing unit of the invention.

### DETAILED DESCRIPTION OF THE INVENTION

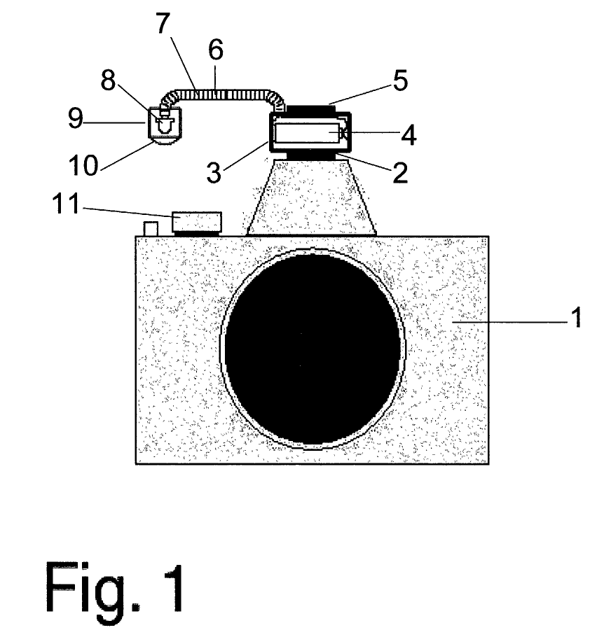

Referring to FIG. 1, an illumination device in accordance with the present invention comprises a male hot shoe bracket (2) that can be used to mount the device onto a photographic camera body (1); a DC power source housing unit (3) which can store a battery (4); a female hot shoe bracket (5), mounted on top of the DC power source housing unit (3), which allows the attachment of an external flash unit onto the camera body (1) via the illumination device; a flexible arm (6) leading two voltage carrying wires (7) from the DC power source housing unit (3) to a light emitting diode (8). The light emitting diode (8) is contained in a light housing unit (9). The light housing unit (9) contains a diffuser (10) which spreads the light emitted by the light emitting diode (8).

The flexible shaft (6) can be bent in any direction, enabling the user to position the light housing unit (9) such that it illuminates the necessary controls (11) and displays of the photographic camera, without obstructing the operation of the camera or other equipment attached to the camera body (1).

The device is attached to the camera body (1) via a male hot shoe bracket (2) attached to the bottom of the DC power source housing unit (3). This type of hot shoe bracket is standard for photographic equipment and is frequently seen on flashes, spirit levels, and supplementary range finders.

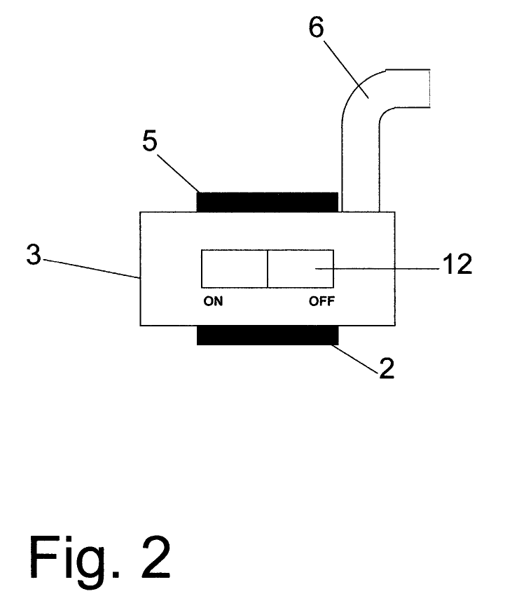

FIG. 2 shows the rear of the DC power source housing unit (3), on which an “ON/OFF” switch (12) can be seen. The said switch controls the power flowing to the light emitting diode (8), effectively allowing the user to turn on or off the illumination device.

What is claimed is:

1. A camera-mounted device specifically designed to illuminate said photographic camera's displays and controls, such device comprising:
a bracket enabling attachment of the device to the body of a photographic camera;
a power source housing unit connected to the bracket;
a light emitting unit attached to and deriving its power from the power source.

2. The illumination device as claimed in claim 1, wherein the camera attachment bracket is a hot shoe.

3. The illumination device as claimed in claim 1, wherein the light emitting unit is a light emitting diode.

4. The illumination device as claimed in claim 1, wherein the position of the light emitting unit relative to the camera body can be adjusted.

5. The illumination device as claimed in claim 1, wherein the light emitting unit is attached to the power source housing unit via a flexible arm.

6. The illumination device as claimed in claim 1, wherein the light emitting unit comprises a diffuser for diffusing light given off by the illumination device.

7. The illumination device as claimed in claim 1, wherein the device further comprises a regulator for varying the intensity of light given off by the illumination device.
